(19) United States
(12) Patent Application Publication
(10) Pub. No.: US 2019/0059557 A1
(43) Pub. Date: Feb. 28, 2019

(54) COSMETIC CONTAINER WITH REMOVABLE PALETTE

(71) Applicant: The Research Council of Makeup Artists Inc., Simi Valley, CA (US)

(72) Inventors: Christian Nygard Kehoe, Simi Valley, CA (US); John-Robert Anders Vincent Kehoe, Simi Valley, CA (US)

(21) Appl. No.: 16/113,897

(22) Filed: Aug. 27, 2018

Related U.S. Application Data
(60) Provisional application No. 62/552,210, filed on Aug. 30, 2017.

(51) Int. Cl. A45D 40/24; A45D 42/00; A45D 33/00; A45D 33/26; A45D 40/18; A45D 40/22

(52) U.S. Cl. CPC A45D 40/24; A45D 42/00; A45D 33/008; G09B 19/0076; A45D 40/18; A45D 40/22; A45D 33/26

(57) ABSTRACT

The present invention generally relates to a cosmetic case or compact, and more specifically relates to a cosmetic case or compact featuring one or more removable cosmetic inserts and a removable palette.

### CROSS-REFERENCE TO RELATED APPLICATIONS

This invention claims the priority benefit of U.S. Provisional Application No. 62/552,210, filed on Aug. 30, 2017, which is incorporated by reference in its entirety.

### FIELD OF THE INVENTION

The present invention generally relates to a new design of cosmetic case or compact, and more specifically relates to a cosmetic case or compact featuring a removable palette.

### BACKGROUND

Cosmetic containers—also referred to as compacts, powder boxes, or powder cases—are portable vessels for holding, storing, and transporting cosmetics. Typically, cosmetic containers are fully enclosed and include one or more types of cosmetics, such as foundations, skin powders, skin creams, eye shadow, mascara, blush, lip gloss, lip stick, or other cosmetics products. Cosmetic containers may include a variety of shades of product, as well as one or more useful accessories such as a mirror or a brush for applying the cosmetic product. Cosmetic containers are typically sized so as to be hand-held and carried in a small bag or purse.

There are many disadvantages to existing cosmetic containers. Historically, each compact could only contain a single cosmetic product, forcing individuals to either limit themselves to a single type or shade of product or to carry multiple containers. Similarly, many compacts were not easily refillable, forcing users to dispose of the compact and purchase a new one once the cosmetic product was exhausted.

Several existing designs seek to address these concerns but still pose significant disadvantages. One example of a compact case with interchangeable cosmetic inserts is provided by U.S. Pat. No. 4,421,127, invented by Marjorie Geer, the disclosure of which is incorporated herein by reference. This design features cosmetic inserts with recesses along their perimeters that are configured to engage with a hinged inner lid with a plurality of openings. While this structure allows individual cosmetic inserts to be replaced, the inner lid used to restrain the cosmetic inserts adds undesirable thickness and complexity to the cosmetic container. Further, it is difficult for a user to remove a single cosmetic insert without accidentally removing the other inserts or spilling the cosmetics contained in the other inserts.

A similar design for a cosmetic make-up kit with replaceable modules is disclosed by U.S. Pat. No. 5,813,420, invented by Morris Sussman, the disclosure of which is incorporated herein by reference. This design features a plurality of cosmetic modules which are held in place by a frame plate with an array of openings. To remove any module, the user must disengage the latch on the frame plate and lift the frame plate, thereby providing access to remove any of the modules. This design also causes undesirable thickness and complexity, with a risk that multiple modules will be removed or spilled while attempting to change a single modules.

Further, while existing cosmetic cases permit users to carry multiple types or shades of cosmetic, they are still inherently limited in that each can only hold a finite number of different cosmetics. Users generally, and cosmetic artists in particular, often need to mix various types or shades of cosmetics together, which is not possible with existing cosmetic containers.

What is needed is an improved cosmetic container that securely contains multiple discrete cosmetic inserts and enables a user to easily remove a single insert without the risk of spilling or accidentally removing the other inserts. Further, a portable device that enables a user to easily mix his or her own cosmetics is also needed. The device and related methods described in the present disclosure address the drawbacks of existing designs.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is a perspective view of a cosmetic container with its lid closed in accordance with one embodiment of the present disclosure.

FIG. 2 is a perspective view of the cosmetic container of FIG. 1 with its lid open.

FIG. 3 is a perspective view of the cosmetic container of FIG. 1 with its lid open and a cosmetic insert removed.

FIG. 4 is a bottom view of the cosmetic container of FIG. 1 with a cosmetic insert removed.

FIG. 5 is a bottom view of a cosmetic insert in accordance with an embodiment of the present invention.

FIG. 6 is a perspective view of the cosmetic container of FIG. 1 with the cosmetic palette and a cosmetic insert removed.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one of skill in the art to which this disclosure relates.

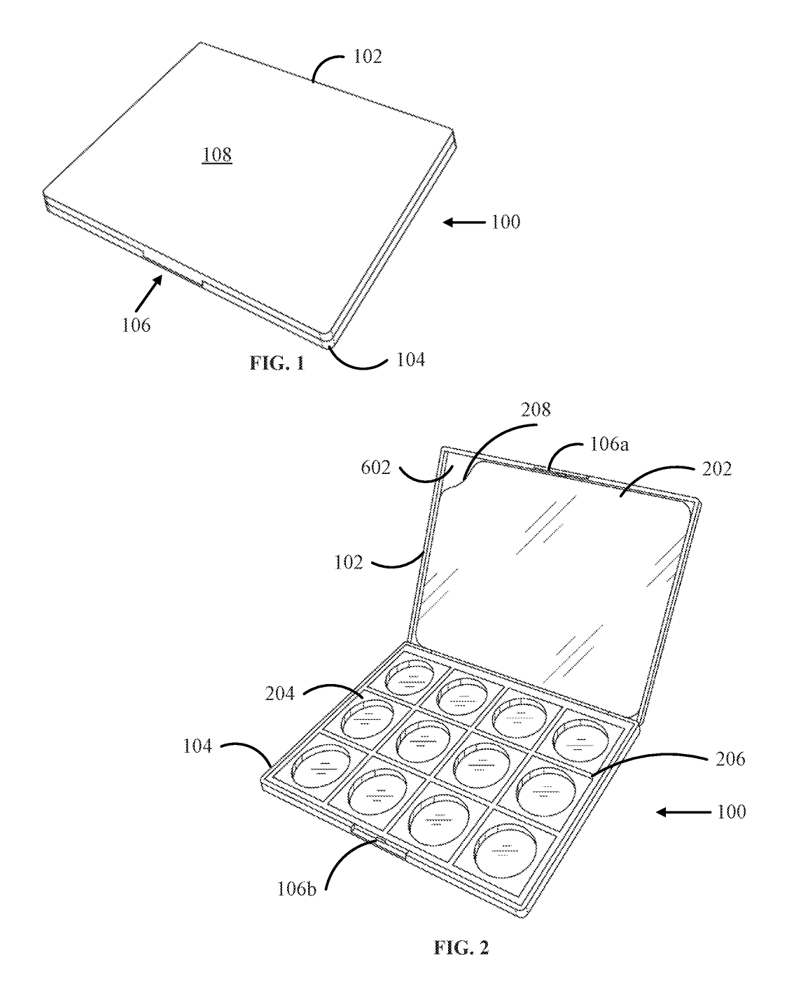

As shown in FIG. 1, a cosmetic container 100 in accordance with an embodiment of the present invention includes a lid 102 and a bottom case 104. The lid 102 may be sealed in a closed position through the use of a latch 106. The exterior surface 108 of the lid may contain decorative or informational matter, such as a manufacturer's name or logo or a decorative design. In an alternative embodiment, the exterior surface 108 may contain instructions for using the cosmetic container 100 or the cosmetics contained therein.

As shown, the cosmetic container 100 forms a rectangular prism with rounded corners. The height of the cosmetic container 100 is substantially less than its length or depth. In an embodiment, the cosmetic container 100 is half an inch tall, 6 and 3/16ths of an inch long, and 4 and ¾ths of an inch deep. In an embodiment, the top case 102 and the bottom case 104 are each a quarter of an inch tall. The cosmetic container 100 may be made from plastic, metal, or another suitable material that is sufficiently rigid to maintain its shape and securely contain cosmetics within the interior of the container 100.

As shown in FIG. 2, the bottom case 104 of the cosmetic container 100 contains a plurality of interior partitions 206 forming a grid, with each space in the grid sized so as to hold a cosmetic insert 204. In an embodiment, the walls 206 forming the grid are each ⅛th of an inch wide, 3/16ths of an inch tall, and are located 1 and ⅜ths of an inch apart from one another. As shown, the grid is regular, with the distance between each of the walls 206 substantially equivalent. Thus, a user may rearrange the inserts 204 (which are all of equal size) as desired. In an alternative embodiment, different size inserts 204 may be used, for example by having different spacing between various walls 206 forming the grid.

Each insert 204 contains a hollow depression 306 surrounded by a raised surface 308. The depression 306 may be filed with a cosmetic, such as a primer, lipstick, lip gloss, lip liner, concealer, foundation, face powder, rouge, bronzer, mascara, eye shadow, eye liner, etc. In an embodiment, the inserts 204 contain various shades of a single type of cosmetic product. Alternatively, in an embodiment, the inserts contain different types of cosmetic products. As will be clear to one of skill in the art, various combinations of cosmetics may be selected based on the particular needs of the users. In an embodiment, the depression 306 is substantially circular in profile and with a diameter of 1 and ⅛th inch and a depth of approximately ⅛th of an inch. As will be clear to one of skill in the art, other dimensions may be used so as to accommodate a greater or lesser amount of a cosmetic product.

A cosmetic palette 202 is located in the top case 102. In a preferred embodiment, the surface of the cosmetic palette 202 is highly reflective so as to function as a mirror, enabling a user to view his or her self while applying cosmetics. The cosmetic palette 202 may be used to mix various cosmetic products together, such as different shades of a single type of cosmetic or even different types of cosmetics. In this way, a user can create a limitless number of desired shades or types of cosmetics from the finite number of cosmetics held within the container 100. In an embodiment, the palette 202 is used by folding the top case 102 back such that it is substantially parallel to the bottom case 104. The container 100 may then be held in a single hand while a person's other hand places cosmetics from the inserts 204 onto the palette 202, mixes the cosmetics, and applies them.

In an embodiment, the palette 202 contains decorative or informational matter over a portion of its surface, such as a manufacturer's name or logo or instructions for use of the cosmetics held within the container 100.

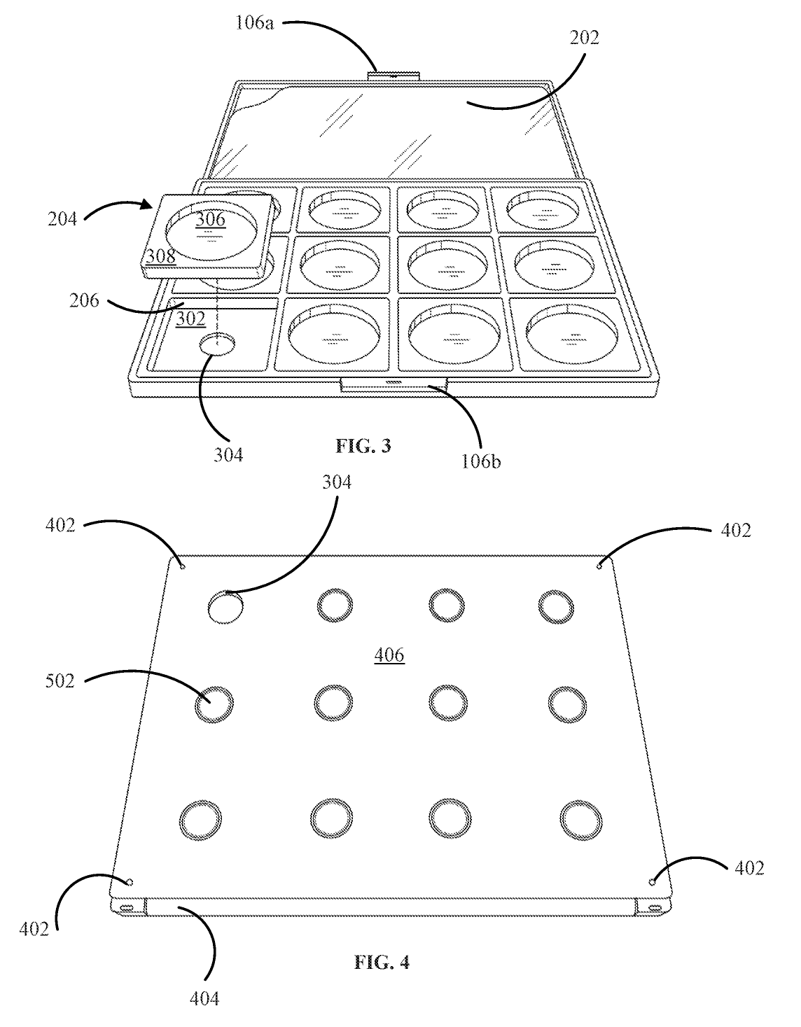

As shown in FIGS. 3, 4 and 5, in an embodiment, each of the inserts 204 may be removed from the container. This enables a user to change out the inserts 204 held within the container 100, for example, to customize the particular variety of cosmetics held within the container 100 at a given time. Similarly, the user may remove an insert 204 to wash it and refill it with additional cosmetic product.

The bottom of each insert 204 includes a protrusion 502 and the bottom case 104 of the container 100 contains a plurality of openings 304, each sized so as to accommodate a protrusion 502. An insert 204 is secured within the container by aligning the insert 204 with the walls 205 in the bottom case 104 and applying pressure to the exterior surface 408 of the insert 204. This presses the protrusion 502 of the insert 204 into and through the corresponding hole 304 in the bottom case 104. The pressure between the walls 206 and the opening 304 in the bottom case 104 and the outer walls 506 and the protrusion 502 of the insert 204, respectively, secure the insert 204 in place.

The protrusion 502 of each insert 204 is substantially flush with the bottom surface 406 of the bottom case 104 when the inserts 204 are located in the container 100. To remove a single desired insert 204, a user applies pressure to the protrusion 502 of the desired insert 104 from below while grabbing the top surface 308 and/or outer walls 510 of the insert 204. This allows a user to remove a single insert at a time without spilling the cosmetic contained in either the insert 204 or the container 100 or getting any of the cosmetic on his or her skin.

The top case 102 may be secured to the bottom case 104 so as to close the container 100 and ensure the cosmetic located within the container 100 does not spill out or come into contact with items located outside the container 100. In an embodiment, the top case 102 includes a latch 106a and the bottom case includes a corresponding recess 106b sized to accommodate the latch 106a. The latch 106a is made from a material with a degree of flexibility and resilience so as to permit the latch 106a to bend away from the recess 106b and thereby engage with and disengage from the recess 106b. Despite being pliable, the latch 106a contains sufficient rigidity to hold the cosmetic container 100 closed once engaged with the recess 106b.

As shown in FIG. 4, the container 100 may include a hinge 404 sized so as to permit the top case 102 to bend back to be substantially parallel to the bottom case 104. The bottom surface 406 of the bottom case 104 may include a plurality of feet 402 sized so as to support the container 100 when it rests on a flat surface.

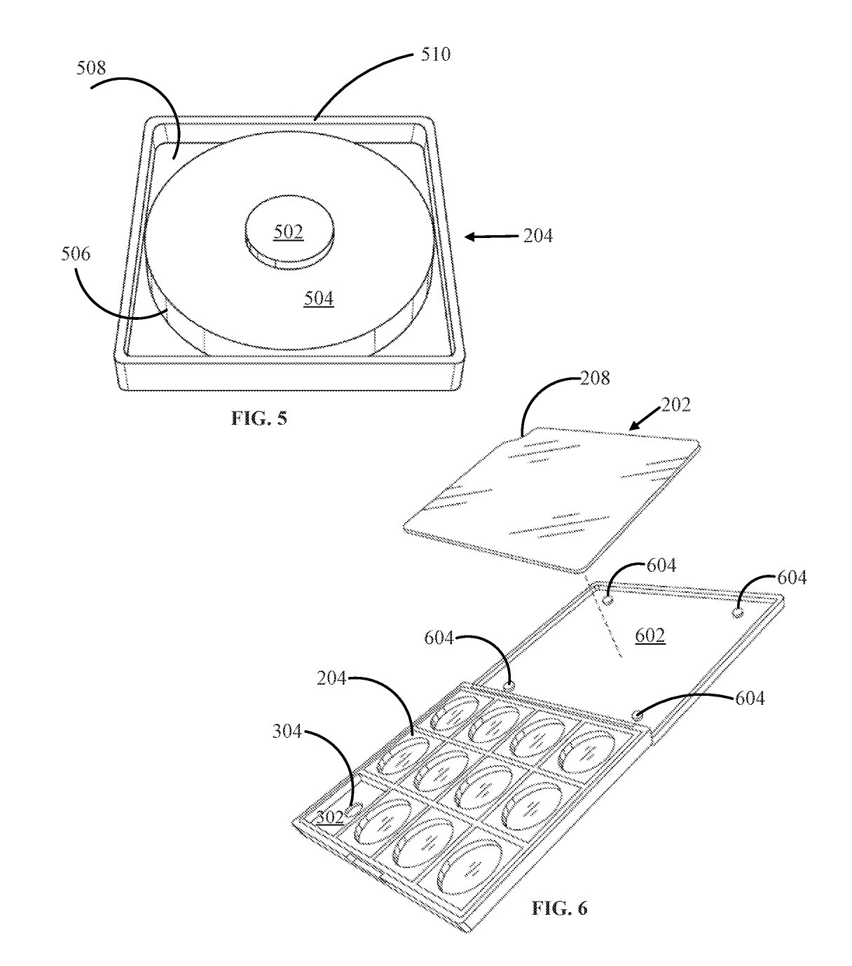

FIG. 5 depicts a perspective view of the lower surface of an insert 204 that has been removed from the container 100. As shown, the protrusion 502 extends away from the lower surface 504 of the depression 306. An exterior wall 506 extends between the lower surface 504 of the depression 306 and the lower surface of the outer face 308 of the insert 104.

As shown in FIG. 6, in an embodiment, the palette 202 (also referred to as a mixing palette) is removably secured within the container. In the embodiment shown, the palette 202 contains a magnetic substance and is held in place in the top case 102 of the container 100 by a plurality of magnets 604 located on the interior surface 602 of the top case 102. To remove the palette 202 from the container 100, a user may insert a finger behind the palette 202 via the indention 208 in the palette 202 and thereby pry the palette 202 away from the top case 102. Once the palette 202 is removed, the user can hold the palette 202 in one hand, for example by using the indentation 208 as a thumb rest and holding the palette 202 with his or her fingers. To secure the palette 202 back in the container 100, the user merely aligns and presses the palette 202 against the interior surface 602 of the top case 102.

In an embodiment, one or more tools for applying cosmetics may be held in the space between the palette 202 and the interior surface 602 of the top case 102. For example, one or more brushes may held by the palette 202 between the palette 202 and the top case 102. To access the tools, the user simply removes the palette 202.

It is understood that the preceding is merely a detailed description of some examples and embodiments of the present invention and that numerous changes to the disclosed embodiments may be made in accordance with the disclosure made herein without departing from the spirit or scope of the invention. The preceding description, therefore, is not meant to limit the scope of the invention but to provide sufficient disclosure to allow one of ordinary skill in the art to practice the invention without undue burden.

What is claimed is:

1. A cosmetic case comprising:
a bottom case with an exterior face opposite an interior face and a passageway extending from the interior face to the exterior face; and
a cosmetic insert with a top surface comprising a depression filled with a cosmetic product opposite a bottom surface having a protrusion with a first end extending away from the bottom surface;
wherein the protrusion is sized and shaped such that with the bottom surface adjacent to and in contact with the interior face, the protrusion extends through at least a portion of the passageway and makes contact with the passageway so as to removably secure the cosmetic insert against the bottom case.

2. The cosmetic case of claim 1, wherein the first end of the protrusion is proximate the exterior face when the bottom surface is adjacent to and in contact with the interior surface.

3. The cosmetic case of claim 1 further comprising a top case movably connected to the bottom case by a hinge.

4. The cosmetic case of claim 3 further comprising a flexible latch protruding from the top case and a corresponding opening in the bottom case, wherein the latch and opening are configured to releasably secure the top case to the bottom case.

5. The cosmetic case of claim 4, wherein the hinge is attached to a rear edge of the bottom case and the opening is on a front edge of the bottom case.

6. The cosmetic case of claim 1 further comprising:
an outer wall projecting away from the interior surface of the bottom case;
a lateral wall projecting away from the interior surface of the bottom case and extending between the outer wall on a first edge of the bottom case to a second edge of the bottom case; and
a longitudinal wall projecting away from the interior surface of the bottom case and extending between the outer wall on a front edge of the bottom case to a rear edge of the bottom case, wherein the longitudinal wall and the lateral wall intersect;
wherein the cosmetic insert is sized to fit in an area between the outer wall, the lateral wall, and the longitudinal wall and the passageway is located in the area.

7. The cosmetic case of claim 6, wherein the outer wall, the lateral wall, and the longitudinal wall each project a first depth away from the interior surface of the bottom case.

8. The cosmetic case of claim 1, further comprising a cosmetic palette removably secured to a lower surface of the top case.

9. The cosmetic case of claim 8, wherein the cosmetic palette comprises a first magnetic substance and the top case comprises a second magnetic substance and the cosmetic palette is magnetically secured to the lower surface of the top case.

10. The cosmetic case of claim 8, wherein the cosmetic palette comprises a polished, reflective surface.

11. A cosmetic case comprising:
a bottom case having a length, a height, and an exterior face opposite an interior face;
a plurality walls projecting away from the interior surface of the bottom case, the plurality of walls comprising:
an outer wall extending along a perimeter of the bottom case;
a plurality of substantially parallel lateral walls extending the length of the bottom case; and
a plurality of substantially parallel longitudinal walls extending the height of the bottom case;
a plurality of recessed areas bounded by the plurality of walls, each of the plurality of recessed areas having a passageway extending from the interior surface to the exterior surface; and
a plurality of cosmetic inserts, wherein each of the plurality of cosmetic inserts comprises:
a bottom surface sized and shaped to fit within a respective one of the plurality of recessed areas;
a top surface opposite the bottom surface, the top surface comprising a depression filled with a cosmetic product;
a protrusion with a first end extending away from the bottom surface, wherein the protrusion is sized and shaped such that with the bottom surface adjacent to and in contact with the interior face, the protrusion extends through at least a portion of and makes contact with the passageway of the respective one of the plurality of areas so as to removably secure the cosmetic insert against the bottom case.

12. The cosmetic case of claim 12, wherein for each of the plurality of cosmetic inserts, the first end of the protrusion is proximate the exterior face when the bottom surface is adjacent to and in contact with the interior surface.

13. The cosmetic case of claim 12 further comprising a top case movably connected to the bottom case by a hinge.

14. The cosmetic case of claim 13 further comprising a flexible latch protruding from the top case and a corresponding opening in the bottom case, wherein the latch and opening are configured to releasably secure the top case to the bottom case.

15. The cosmetic case of claim 14, wherein the hinge is attached to a rear edge of the bottom case and the opening is on a front edge of the bottom case.

16. The cosmetic case of claim 11, wherein each of the plurality of walls project a distance away from the interior surface of the bottom case.

17. The cosmetic case of claim 11, further comprising a cosmetic palette removably secured to a lower surface of the top case.

18. The cosmetic case of claim 17, wherein the cosmetic palette comprises a first magnetic substance and the top case comprises a second magnetic substance and the cosmetic palette is magnetically secured to the lower surface of the top case.

19. The cosmetic case of claim 17, wherein the cosmetic palette comprises a polished, reflective surface.

20. A method of removably securing a cosmetic insert comprising a bottom surface having a protrusion with a first end extending away from the bottom surface within a cosmetic case comprising a bottom case with an exterior face opposite an interior face and a passageway extending from the interior face to the exterior face, the method comprising the steps of:
positioning the bottom surface adjacent to the interior surface such that the first end is proximate the passageway; and
inserting the protrusion into the passageway until the bottom surface contacts the interior surface and the first end is proximate the exterior face.

21. A cosmetic case comprising:
a top case, wherein the interior surface of the top case contains a magnet;
a bottom case, wherein the interior of the bottom case contains two spaced apart walls with a recess and an opening extending from the interior surface of the bottom case to the exterior surface of the bottom case located therebetween;
a hinge movably connecting the top case to the bottom case;
a latch located on the top case and a corresponding recess on the bottom case for securing the top case to the bottom case;
a cosmetic insert with a top surface and a bottom surface, wherein the top surface of the insert contains a depression filled with a cosmetic product, the bottom surface includes a protrusion extending perpendicularly away from the bottom surface, the cosmetic insert is sized so as to fit in the recess, and the protrusion is sized to extend through the opening when the bottom surface of the insert rests on the interior of the bottom case; and
a cosmetic palette containing a magnetic material.
